(19) United States
(12) Patent Application Publication
(10) Pub. No.: US 2007/0283235 A1
(43) Pub. Date: Dec. 6, 2007

(54) Montage Method

(76) Inventors: John D. Piper, Cambridgeshire (GB); Peter T. Fry, Cambridgeshire (GB); Richard F. Long, Leighton Buzzard (GB); Colin Hardingham, Bushey (GB); Martyn Lambert, Watford (GB); Karen L. Lawson, Logie Trail (GB)

Correspondence Address: EASTMAN KODAK COMPANY;PATENT LEGAL STAFF, 343 STATE STREET, ROCHESTER, NY, 14650-2201, US

(21) Appl. No.: 11/573,854

(22) PCT Filed: Aug. 4, 2005
(86) PCT No.: PCT/GB05/03070

§ 371 Date: Jul. 31, 2007

(30) Foreign Application Priority Data
Aug. 19, 2004 (GB) 0418444.6

(51) Int. Cl. H04N 1/387

(52) U.S. Cl. 715/500

(57) ABSTRACT

A computing system, composed of a series or set of algorithms which are relevant to either the layout or composition of a photomontage, is applied to a plurality of images. This system can be operated either by a human user specifying placement and location of a plurality of digital images, called an image set, onto a specified output size or the system itself acts to generate, through a series of placement and compositional steps, the montage onto the specified output size. The system can be operated in either mode at any point through the operation as specified by the user. In the fully automated system the image analysis algorithms and the resulting information is placed within the appropriate vector in a data array of the system and henceforward available to the system of the invention for evaluation of the montage score once the generation of the montage is complete. The evaluation of the overall resulting multi-image montage with the same image analysis algorithms is then used to determine the fitness of the resultant montage and the fitness is then compared with the objective or target function for the desired montage.

### FIELD OF THE INVENTION

This invention relates to the field of the creation of a montage of images.

### BACKGROUND OF THE INVENTION

There has been a substantial increase in the uptake of digital capture technologies within consumer markets over the recent past. This increase in the uptake of digital capture has resulted in two fundamental changes in picture taking and use behaviour amongst consumers. Both changes have made immense financial impact on the manufacturers of conventional silver halide film.

Firstly, digital capture renders film redundant and reduces the cost of image capture to substantially zero, excluding the equipment cost. This reduction in cost constraints has led to an increase in the amount of personal pictures taken by each digital camera and a decrease in the amount of roll film purchased. Secondly, only a small proportion of these digital pictures are printed on photographic paper. Of those that are printed a large proportion are printed on inkjet paper rather than photographic paper.

### Problem to be Solved by the Invention

These behavioural changes and their impact on the manufacturers of photographic film and paper mean that it is necessary to provide different hardcopy products to cater for these changes. For example the 6×4 print was originally designed to deliver hardcopy photographs for households shooting just a few rolls of film per year. Now with digital capture products these same households are now capturing literally thousands of digital pictures over a very short period of time. Manufacturers of conventional silver halide film continue to base photographic output business on the same old traditional formats that have always been offered, with no consideration or adaptation of this behaviour change.

With the advent of digital capture and soft display it is now possible to create new formats of hardcopy or output prints which give compelling reasons for consumers to choose hardcopy photographic prints over other forms of display and storage. New automated forms of output products will provide novel ways for customers to experience their digitally captured images while allowing them to retain those experiences longer and in more convenient ways than ever before.

Multiple image sets have the ability to tell a story about a scene or event when combined in one output form, defined as a montage. On many occasions a photomontage using a plurality of pictures may invoke a greater response from the viewer than the same pictures viewed individually and therefore has a higher emotional quality. It is also proposed that photomontages of events provide a truer representation of the nature and experience of the event than a series of single images. Additionally, a montage of lower quality images is also capable of masking this perceived lower quality by focusing attention on the overall theme of the multi-image set and away from the minute details of each individual image. Sets of lower resolution images from a mobile phone, for example, which have been compiled together to form a montage, can therefore produce a single picture of higher ‘quality’ in terms of emotion and meaning, than any of the pictures on its own.

### SUMMARY OF THE INVENTION

The invention allows the easy creation of a photomontage from a plurality of digital images.

According to the present invention there is provided a method for the automatic generation of a montage of images comprising the steps of;

inputting a plurality of images to be used in creating the montage,

determining the size of the montage to be created,

setting up a memory data array of vector information for each of the plurality of images,

setting up options and parameters relevant to the creation of a montage,

evaluating each image through image analysis algorithms to ascertain essential metadata and inputting the resulting data into the array,

determining the constraints to which the montage is limited,

randomly choosing a starting point at which the first image will be placed,

reserving places for all subsequent images in accordance to the constraints;

carrying out a validation test to determine if the montage is acceptable;

if acceptable placing the images in the places reserved for them and displaying the resulting montage and if not acceptable going back to the step of choosing a random starting point.

The invention further provides a system for the automatic generation of a montage of images comprising;

means for inputting a plurality of images to be used in creating the montage,

means for determining the size of the montage to be created,

means for setting up a memory data array of vector information for each of the plurality of images,

means for setting up options and parameters relevant to the creation of a montage,

analysis means for evaluating each image through image analysis algorithms to ascertain essential metadata and means for inputting the resulting data into the array,

means for determining the constraints to which the montage is limited,

means for randomly choosing a starting point at which the first image will be placed and placing the first image at that point,

means for placing all subsequent images in accordance to the constraints;

validation means for carrying out a validation test to determine if the montage is acceptable; and

means for displaying the resulting montage.

### ADVANTAGEOUS EFFECT OF THE INVENTION

The invention is very easy to use. This ease of use has been achieved by designing the software to perform only one optimised task, i.e. the creation of a photomontage. The single composite picture produced by the method is of higher emotional quality and hence, consumer value than any single shot.

The automated process of composing the photomontage relies on parameters and iterative processing using previously acquired information to derive a preferred form for the customer. The automated process takes the majority of the layout work for the creation of a montage away from the user and provides a series of optimal montage layouts to the user from which they can then tailor the multi-image product to their specific preferences. By using optimisation techniques developed for this invention, there is much less data used during the creation of the montage and therefore much less computational energy.

### BRIEF DESCRIPTION OF THE DRAWING

FIG. 1 is a flow chart illustrating the steps of the invention.

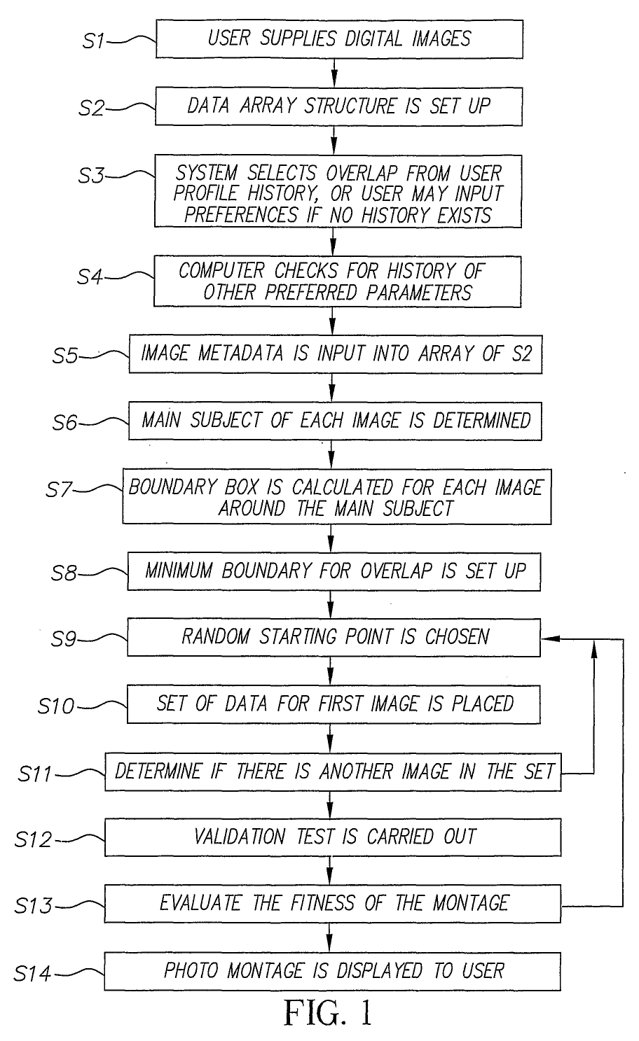

### DETAILED DESCRIPTION OF THE INVENTION

In step S1 a user supplies a number of digital images, set A, through the interface into the system of the invention described herein and sets the output size of the photomontage to be created from a set of pre-determined output size options.

In step S2 a data array structure is set up in a memory for the overall montage creation process with a vector of elements allocated for each image in set A. This vector is intended for the accumulation of information over the process, such as the original size of the image. No image data is stored in this array structure but each vector maintains a pointer, or URI to the original image data. This pointer based system keeps memory utilization to a minimum at this stage.

In step S3, the system can either select from a set of historical data maintained in the user profile of use with the system or the user may input, if no previous history of usage exists, his/her preferred overlap between images in the final montage. This can be either positive or negative, where a positive gap will increase the white space between each image and a negative gap will increase the overlap potential of the images.

In step S4 the computer checks to see if there is any history of other preferred parameters by the user for the execution of the montage compilation. From previous montage creation completion processes, a historical record is written which includes the data, time and user and other such information. The historical record can also include the extent of preferred overlap, colour distribution score, and any other such information as the user of the system chooses to store and reuse.

Once the computer has retrieved all needed parameter data, the system will now process each input image to ascertain its original data. In step S5 the image metadata is input into the array created in step S2. The data is an extensible vector list which includes such things as the sizes of the original images, in x and y directions, the image orientation and colour distributions by channel. Additional information will be ascertained about the image using image analysis algorithms and the results of the analysis are then supplied as another component of the vector.

The main subject of each image is determined in step S6. The main subject can be determined by known algorithms and will not be described further. The image orientation, i.e. landscape or portrait, is also determined. The colour distribution of each image could also be determined. This is not an essential feature for the method of the invention but may be included in a preferred embodiment.

Next, in step S7, a boundary box, s(x,y), is calculated for each image around the main subject of that image, the main subject being determined in step 6. The boundary box is set up to be slightly bigger than the main subject area. The boundary box ensures that the images are not overlapped to such an extent that the main subject area is not seen in the final montage.

All of these parameters are stored as metadata and can be stored on a file specific to a particular set of images to be used in the creation of a montage.

In step S8 a minimum boundary for overlap is set up. This minimum boundary is equal to the calculated boundary box for each image.

All steps up to this point are performed before the computer begins to layout a montage.

The creation of the montage begins with step S9. A random starting point is chosen, step S9, and the set of data for a first image is placed here, step S10. In step S11 it is determined if there is another image in the set. If yes, data in respect of that next image is placed at a location that attempts to meet alf the constraints put on the system. Each subsequent set of data from the array is placed at a location that attempts to meet all the constraints put on the system. These constraints are that there is no overlap of main subject areas, that the images are in the correct orientation and that the preferred overlap of images is maintained. These are the constraints put upon the system as described. It will be understood by those skilled in the art that further constraints could be put upon the system. For example, the colour distribution of the montage must be uniform, shape distribution must be even, and an even distribution of landscapes preferred. These are examples only of further algorithmic constraints that can be placed on the overall system of the invention. The constraints of the system are based on the relevant image analysis algorithms which can be included in the evaluation of the resulting montage.

The high resolution images themselves are not manipulated at any time during the creation steps. A lower resolution, transparent image is used for the determination of placement in the montage. Only after the user is satisfied with the general layout and look of the photomontage are the high resolution images requested from the server and placed in layout.

This process of placing an image continues until all images in the set have a place reserved in the montage. If there is not room for all the images the process starts again from step S9, i.e. the choosing of a random starting point.

Once each image in the set has a reserved place, i.e. when the virtual montage is ready, a validation test is carried out, step S12. Every option/constraint is given a score, the higher the better. A score is given if the overlaps are acceptable, the closer the average overlap is to the preferred specified overlap the higher the score. A score is also given for composition elements of the overall montage. The colour distribution can be calculated as the sum of average colour distributions per RGB channel over each predefined spatial region of the resulting montage. The summation will be closest to one when the colour distributions of the regions of the montage are evenly distributed. For example, regions of high density red in the resultant montage when evaluated using the colour distribution analysis algorithm will cause the colour distribution in those regions to score lower thus bringing the overall colour distribution score for the composition component of the generated montage lower

Step S13 evaluates the fitness of the montage. The fitness of the montage is the summation of all the scores as they relate to the different parameters of the montage, i.e. the layout score and the composition score as determined in step S12. For automated montage creation, the montage algorithm will have an objective or target score for each category of layout and composition and a combined overall score. This score represents the mathematical equivalent of the optimal automated montage selection based on the parameterised values provided.

If the score is greater than the objective then the images are placed in the montage and the photomontage displayed to the user in step S14. If the user likes the montage all the parameters are stored and can be used in the preference history for later use in creating other montages from different sets of images. A hardcopy of the photomontage may be printed.

If the score is not greater than the objective then the system goes back to step S9 and a further random starting point chosen.

The method and system of invention allows two modes of operation, user driven and fully automated. In the fully automated mode, the system will strive to achieve a montage which scores closest to the objective or target score through the process of repetitive layout and composition steps as defined in step s9 through s12. In the user driven mode, the user will act to select the montage layout and composition that is desired and no automated scoring system in then used or required. The system can be switched between these two modes by the user at any time.

The user may select an image contained within the completed montage and seek to move the image. The system will then use this new position as a starting point and will ask the user to input whether an automated or user driven montage is desired. Based on the response from the user the system will either permit the free-form creation of the montage or will use the newly placed image as the starting position for the fully automated montage layout and composition process.

The method can be deployed across a broad range of platforms, i.e. the web, home computing, kiosk, mobile phones etc.

The invention has been described in detail with reference to preferred embodiments thereof. It will be understood by those skilled in the art that variations and modifications can be effected within the scope of the invention.

1. A method for the automatic generation of a montage of images comprising the steps of:
inputting a plurality of images to be used in creating the montage;
determining the size of the montage to be created;
setting up a memory data array of vector information for each of the plurality of images;
setting up options and parameters relevant to the creation of a montage;
evaluating each image through image analysis algorithms to ascertain essential metadata and inputting the resulting data into the array;
determining the constraints to which the montage is limited;
randomly choosing a starting point at which the first image will be placed;
reserving places for all subsequent images in accordance to the constraints; and
carrying out a validation test to determine if the montage is acceptable;
if acceptable, placing the images in the places reserved for them and displaying the resulting montage and if not acceptable, going back to the step of choosing a random starting point.

2. A method as claimed in claim 1, wherein the options include the amount of overlap between images in the montage.

3. A method as claimed in claim 1, wherein the constraints to which the montage is limited, includes at least one of:
no overlap of the main subject area of each image;
correct orientation of each image; and
preferred overlap of images is maintained.

4. A method as claimed in claim 3, wherein to ensure no overlap of the main subject of each image the main subject of each image is determined and a boundary box is set up which encloses each main subject.

5. A method as claimed in claim 1 wherein the validation test comprises providing every constraint with a score, the magnitude of the score determining whether or not the montage is acceptable.

6. A method as claimed in claim 5, wherein the full montage is scored and the score is compared with an objective score, the montage being found acceptable if the score is greater than the objective score.

7. A method as claimed in claim 6, wherein the information concerning any acceptable montage generated either through user driven activity or through fully automated montage creation is then stored and accessible for subsequent use in preparation of future montages.

8. A system for the automatic generation of a montage of images comprising:
means for inputting a plurality of images to be used in creating the montage;
means for determining the size of the montage to be created;
means for setting up a memory data array of vector information for each of the plurality of images;
means for setting up options and parameters relevant to the creation of a montage:
analysis means for evaluating each image through image analysis algorithms to ascertain essential metadata and means for inputting the resulting data into the array;
means for determining the constraints to which the montage is limited;
means for randomly choosing a starting point at which the first image will be placed and placing the first image at that point;
means for placing all subsequent images in accordance to the constraints;
validation means for carrying out a validation test to determine if the montage is acceptable; and
means for displaying the resulting montage.
